(19) United States
(12) Patent Application Publication
(10) Pub. No.: US 2017/0217587 A1
(43) Pub. Date: Aug. 3, 2017

(54) VEHICLES AND SYSTEMS FOR WEATHER MODIFICATION

(71) Applicant: JG Entrepreneurial Enterprises LLC, Wilmington, DE (US)

(72) Inventor: John Goelet, Washington, DC (US)

(21) Appl. No.: 15/417,175

(22) Filed: Jan. 26, 2017

Related U.S. Application Data
(60) Provisional application No. 62/288,802, filed on Jan. 29, 2016.

(51) Int. Cl. B64C 39/02; A01G 15/00; G05D 1/00; B64D 1/18; B64D 1/02; B64D 39/06

(52) U.S. Cl. CPC B64C 39/02; B64D 1/02; B64D 39/06; B64C 39/024; G05D 1/0022; B64D 1/18; A01G 15/00; B64D 2211/00; B64C 2201/021; B64C 2201/042; B64C 2201/082; B64C 2201/104; B64C 2201/12; B64C 2201/146; B64C 2201/206

(57) ABSTRACT

A weather modification system that includes both systems and vehicles capable of modifying the weather. The systems may include devices capable of utilizing compositions to create dispersants that can modify weather. The system is capable of autonomous weather modification where the vehicles may operate for long periods of time in the air and may be directed by a control station. The vehicles may include an airplane, a UAV, a balloon, a satellite, an airship, such as a lenticular airship, a helicopter or a lighter than air vehicle. The vehicles are capable of multiple functions including weather modification, weather monitoring, and coordination between different vehicles.

### PRIORITY CLAIM

This application claims priority from U.S. Provisional Patent Application No. 62/288,802, filed on Jan. 29, 2016, the entire disclosure of which is incorporated by reference in the present application.

### TECHNICAL FIELD

The present disclosure relates generally to weather modification and, more particularly, to vehicles and system for weather modification.

### BACKGROUND

Global warming has caused drastic changes to global weather and many areas have experienced abnormal weather patterns. For example, some traditionally dry regions have received extraordinary large volumes of rainfall, causing unexpected flooding. On the other hand, some traditionally precipitation-rich regions have experienced historical drought, devastating agriculture that depends heavily on the weather. At least due in part to the global warming caused by the increased industrial activities, global weather has become more unpredictable and the effects more severe.

A number of technologies have been developed to affect, modify, or manipulate weather. One known technology is cloud seeding, which has been implemented in dry regions to create or increase precipitation. To seed a cloud to produce precipitation, cloud seeding materials or compositions, for example silver iodide (AgI), silver oxide, or dry ice, are distributed into the cloud. The distribution helps facilitate formation of rain droplets or snowflakes from small water droplets suspended within the cloud. The cloud seeding materials can be distributed into the clouds in various ways. Traditionally, they have been distributed into the clouds by flares, rockets, or cannons. Cloud seeding materials can also be introduced into the air by an exhaust produced by a ground-based cloud seeding generator burning, for example, a gas (e.g., propane).

There are, however, disadvantages and shortcomings associated with the existing cloud seeding technologies. To be effective, cloud seeding requires correctly identifying a candidate cloud and undertaking cloud seeding at the correct time. In other words, in order to create precipitation from a cloud, the cloud must have the right conditions, such as the right amount or size of water droplets, temperature, humidity, etc. Not every cloud is a good candidate for cloud seeding. In particular, spreading cloud seeding materials in the wrong clouds would not create precipitation, rain or snowfall, from the clouds. Thus, identifying the right candidate cloud is an important first step for effective cloud seeding. These traditional technologies, however, may not accurately identify a correct cloud candidate to receive cloud seeding due to, in part, the lack of information relating to the conditions of the cloud. When cloud seeding is applied to a mistakenly identified cloud that does not have the right conditions for forming precipitation, a cloud seeding operation results in an unsatisfactory amount of precipitation or no precipitation, which can be a waste of time, energy, and materials.

After the candidate cloud is identified, cloud seeding materials may be spread or distributed to the cloud using traditional methods such as flares, rockets, or cannons. The existing technologies, however, do not allow for long term cloud seeding operations or automatic cloud seeding operations. In addition, these technologies may lack accuracy in spreading the materials to the cloud.

The current technologies have downtime when no cloud seeding takes place. During downtime, a candidate cloud could dissipate, undergo changes in weather conditions, or leave the target precipitation area. For example, a cannon requires downtime for maintenance, resupply, and rest for operators. During the downtime no cloud seeding operations can occur which inhibits continuous cloud seeding operations or operations that are automated. Currently, a user must initiate cloud seeding when conditions are right, such as by firing a cannon into a candidate cloud. A cloud seeding method that allows for greater uptime is needed to increase the availability of cloud seeding. Such a system would allow for greater opportunities to seed clouds and also more efficient cloud seeding operations.

Other technologies have been developed to manipulate or modify weather in order to interfere, disrupt, or prevent the formation of storms, such as hurricanes, tornados, or hail. For example, people have attempted to spread certain materials, such as, for example, silver iodide or a polymer powder, into clouds to reduce or change the conditions surrounding the water droplets suspended within the clouds, thereby reducing the possibility of forming a harmful storm. People have also developed other ideas to reduce the formation of hazardous weather. For example, hail cannons have been used to generate waves at certain frequencies towards the clouds to prevent formation of hail. These technologies share common drawbacks with the existing cloud seeding technologies, e.g., the lack of precision in targeting the right clouds, the persistence of downtime and the inability to continuously operate.

The present disclosure is directed toward improvements in existing technologies for manipulating or modifying weather.

### SUMMARY

In one exemplary embodiment, the present disclosure is directed to a weather modification vehicle. The weather modification vehicle includes a hull and at least one wing connected to the hull. The weather modification vehicle also includes at least one weather modification device attached to at least one of the hull and the at least one wing and configured to generate a dispersant for modifying weather using at least one weather modification composition. The weather modification vehicle also includes a solar panel installed on a surface of at least one of the hull and the at least one wing and configured to generate electricity from solar energy.

In another exemplary embodiment, the present disclosure is directed to a weather modification vehicle. The weather modification vehicle includes a hull, at least one wing connected to the hull, and an auxiliary vehicle attached to at least one of the hull and the at least one wing. The auxiliary vehicle carrying a weather modification composition for modifying weather and the auxiliary vehicle is deployable from at least one of the hull and the at least one wing.

In yet another exemplary embodiment, the present disclosure is directed to a system for weather modification. The system includes a plurality of weather modification vehicles deployable in the air. Each of the vehicles includes a hull, at least one wing connected to the hull, and at least one weather modification device attached to at least one of the hull and the at least one wing and configured to generate a dispersant for modifying weather using at least one weather modification composition. Each of the vehicles also includes a solar panel installed on a surface of at least one of the hull and the at least one wing and configured to generate electricity from solar energy. The system further includes a control station configured to control the operation of the plurality of weather modification vehicles for modifying weather.

In yet another exemplary embodiment, the present disclosure is directed to a system for weather modification. The system includes a plurality of weather modification vehicles. Each of the vehicles includes a hull, at least one wing connected to the hull, and an auxiliary vehicle attached to at least one of the hull and the at least one wing. The auxiliary vehicle carrying a weather modification composition for modifying weather, and is deployable from at least one of the hull and the at least one wing. The system further includes a control station configured to control the operation of the plurality of weather modification vehicles for modifying weather.

### BRIEF DESCRIPTION OF THE DRAWINGS

The accompanying drawings, which are incorporated in and constitute part of this disclosure, together with the description, illustrate and serve to explain the principles of various example embodiments.

FIG. 1 illustrates an exemplary weather modification system, consistent with disclosed embodiments;

FIG. 2 illustrates an exemplary weather modification system having a flare system, consistent with disclosed embodiments;

FIG. 3 illustrates an exemplary weather modification system having a flare system, consistent with disclosed embodiments;

FIG. 4A illustrates an exemplary weather modification system having auxiliary vehicles, consistent with disclosed embodiments;

FIG. 4B illustrates an exemplary weather modification system having auxiliary vehicles, consistent with disclosed embodiments;

FIG. 4C illustrates an exemplary weather modification system having auxiliary vehicles, consistent with disclosed embodiments;

FIG. 4D illustrates an exemplary auxiliary vehicle, consistent with disclosed embodiments;

FIG. 5 illustrates an exemplary weather modification system having generators, consistent with disclosed embodiments;

FIG. 6 illustrates an exemplary weather modification system having a projectile launching system, consistent with disclosed embodiments;

FIG. 7 illustrates an exemplary weather modification system having missiles, consistent with disclosed embodiments;

FIG. 8 illustrates an exemplary weather modification system having a beam emitter, consistent with disclosed embodiments;

FIG. 9 illustrates an exemplary system for weather modification including a control system, consistent with disclosed embodiments;

FIG. 10 illustrates an exemplary command center, consistent with disclosed embodiments;

FIG. 11 illustrates an exemplary transfer device used in a weather modification system, consistent with disclosed embodiments; and

FIG. 12 illustrates an exemplary solar power supply system used in a weather modification vehicle, consistent with disclosed embodiment.

### DETAILED DESCRIPTION

Reference will now be made in detail to the drawings. Wherever convenient, the same reference numbers will be used throughout the drawings to refer to the same or like parts.

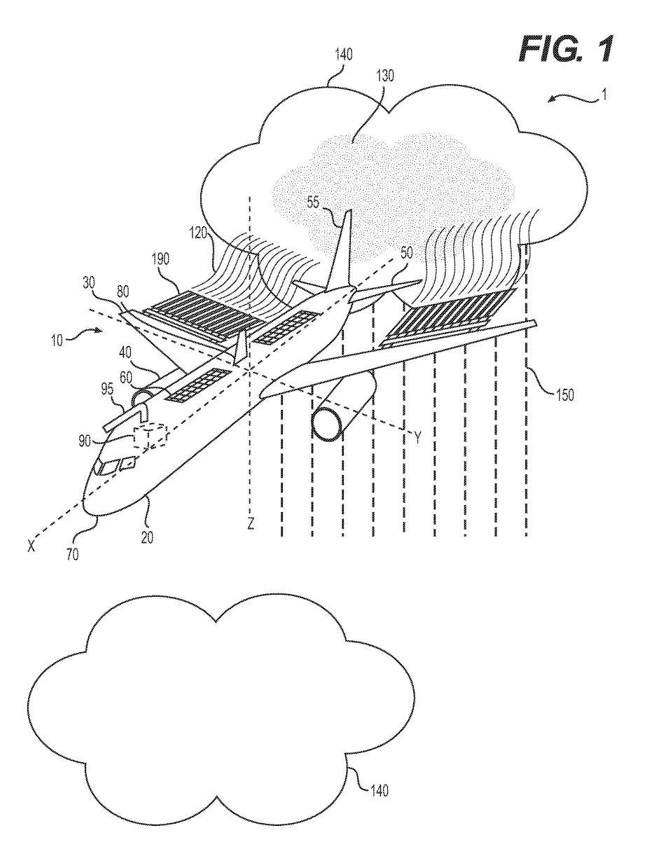

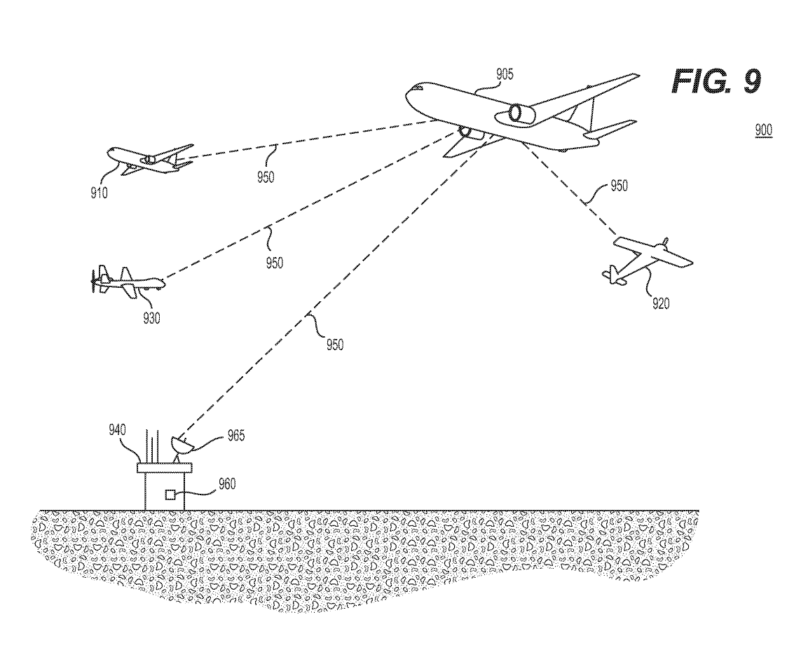

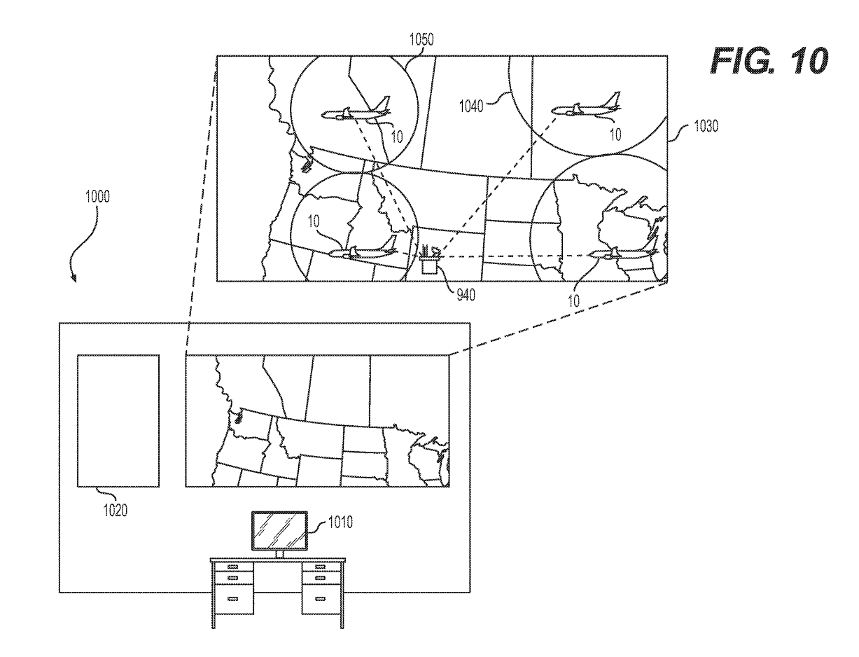

FIG. 1 illustrates an exemplary weather modification system according to some embodiments of the present disclosure. As shown in FIG. 1, for example, a weather modification system 1 may include a weather modification device 110 attached to a vehicle 10. Vehicle 10 navigates above, below, around, or through target clouds 140, which may be determined by a control station 940 (shown in FIGS. 9 and 10) or an onboard control unit 90 included in vehicle 10. Once near target clouds 140, weather modification device 110 may utilize a weather modification composition to create a dispersant 120 that is directed towards a target cloud 140. Dispersant 120 may facilitate formation of water droplets or ice crystals 130 (or a mixture thereof) within target cloud 140. Eventually, the water droplets and ice crystals may become precipitation 150 (e.g., rain or snow fall), and fall to the ground. As explained below, different weather modification devices 110 and different weather modification compositions may be used in weather modification system 110.

In some embodiments, weather modification device 110 may utilize cloud seeding to form precipitation. In cloud seeding, weather modification devices 110 may create dispersant 120 from weather modification compositions, such as silver iodide, silver oxide, liquid carbon dioxide, dry ice, liquid propane, hydrophilic sodium alginate, a beam emission, or hygroscopic materials, such as table salt. For example, weather modification devices 110 could burn or eject the weather modification compositions into target cloud 140 using flare systems 200, generator system 500, projectile launching systems 600, missile systems 700, or beam emission systems 800. The weather modification devices may then spread dispersant 120 into target cloud 140. Dispersant 120 may help form water droplets and/or ice crystals 130 within target cloud 140. The water droplets and/or ice crystals 130 may attract moisture and fall from target cloud 140 as precipitation 150.

Weather modifying vehicle 10 may include an aircraft, such as an airplane, which is capable of operating for long periods of time at various altitudes where target clouds 140 are located. Other types of aircraft may be utilized, such as a balloon, a satellite, an airship (e.g., a lenticular airship), a helicopter, an unmanned aerial vehicles, and other lighter-than-air vehicles. Vehicle 10 may be configured for deployment in the air. For example, vehicle 10 may navigate (e.g., fly) in three dimensions (e.g., around the X, Y, and Z axes shown in FIG. 1) in the sky.

Vehicle 10 may include a hull 20 and at least one wing 30 (e.g., a single wing, a pair of wings, or multiple wings) connected to hull 30. Vehicle 10 may also include at least one tail wing or fin 50. Vehicle 10 may include at least one propulsion assembly 40 coupled to at least one of hull 20, at least one wing 30, or at least one tail wing 50.

Hull 20 may include a support structure (not shown) and a surface (or skin) covering the support structure. Support structure may be defined by one or more frame members that define the shape of hull 20. Hull 20 may also connect various components of the vehicle 10 together, such as the at least one tail wing 50 and at least one wing 30.

At least one propulsion assembly 40 shown in FIG. 1 may include an engine configured to propel the vehicle 10 in flight operations, such as a traditional jet or propeller engine, or an engine having propellers powered by an electric motor. The at least one propulsion assembly 40 may also comprise any device that may provide propulsion including vertical takeoff and landing (VTOL) propulsion. In some embodiments, vehicle 10 may be an airship or a balloon (e.g., a hot balloon), which may float in the air using a gas that is lighter than air, or using hot air, and may not include propulsion assembly 40. In some embodiments, at least one propulsion assembly 40 may still be included with vehicle 10 when vehicle 10 is an airship or a balloon.

In some embodiments, vehicle 10 may include a solar power supply system 60 configured for generating electricity from solar energy. Electricity generated from solar energy may be used by vehicle 10 to power electronics included in vehicle 10, and/or at least one propulsion assembly 40 (e.g., an electric motor included in at least one propulsion assembly 40 that drives a propeller). Solar power supply system 60 may include one or more solar panels attached to a surface of vehicle 10, such as an upper surface of hull 20, at least one wing 30, and/or at least one tail wing 50. In some embodiments, solar panels may cover a substantial area (e.g., 50%, 70%, 80%, 90%, etc.) of the upper surface of hull 20, at least one wing 30, and/or at least one tail wing 50.

Vehicle 10 may include a communication device 80 configured to communicate with other devices, vehicles, or control stations by suitable communication means, such as radio frequency signals, WiFi signals, cellular signals, laser or other optical signals, etc. Communication device 80 may transmit data to other vehicles or control stations, such as data reflecting weather conditions (e.g., conditions of clouds) measured by at least one sensor included in vehicle 10, or measured by a sensor included in an auxiliary vehicle that communicates with vehicle 10. Data transmitted to the other vehicles or control stations by communication device 80 may also include data reflecting the navigation of vehicle 10 (e.g., fly operations, aerodynamic status of vehicle 10, etc.). In some embodiments, the data may also include data indicating a status of a weather modification operation (e.g., a cloud seeding operation status), as well as the amount of weather modification composition or material remaining in the weather modification device 110. Communication device 80 may also be configured to receive data from other vehicles or control stations. For example, communication device 80 of vehicle 10 may receive control commands or signals from a control station, which may be air-based, sea-based, or ground-based. Commands or signals from the control station may relate to the operation (e.g., navigation or weather modification operation) of vehicle 10. For example, commands may include instruction to vehicle 10 to fly to a certain area to perform weather modification tasks, instructions to vehicle 10 to start measuring weather conditions over an area in the sky (e.g., conditions of clouds) and send data back to control station. Commands may also include commands related to the timing for generating and/or releasing dispersant 120 (e.g., when to generate and/or release), and amount of dispersant 120 to be generated in a weather modification operation. Commands may further include instructions related to the deployment of one or more auxiliary vehicles from vehicle 10 for weather modification, such as, for example, when to deploy the one or more auxiliary vehicles, the number of auxiliary vehicles to be deployed, where they are to be deployed, and the amount of dispersant 120 each of the auxiliary vehicles will generate for a weather modification operation.

Vehicle 10 may include a control unit 90. Control unit 90 may include a processor configured to process data. Any suitable processor may be used. For example, the processor may be configured to process data related to the navigation of vehicle 10 (e.g., flight control), which may be received from various sensors included in vehicle 10, or may be received from a control station. In some embodiments, the processor may be configured to process data related to other operations of vehicle 10, such as weather modification operations. For example, the processor may process data received from weather modification device 110, which may indicate the amount of weather modification composition used for weather modification or remaining in vehicle 10. The processor may analyze the data received from weather modification device 110 to determine a status of a weather modification operation, timing for generating and releasing dispersant 120, and amount of dispersant 120 to be generated. The processor may also process data received from auxiliary vehicles relating to, for example, the navigation of the auxiliary vehicles, and/or the status of weather modification operations conducted by the auxiliary vehicles. Control unit 90 may include circuits for processing electrical signals and memory for storing data.

Vehicle 10 may also include at least one sensor 95 configured to measure weather information or conditions from the air. The weather conditions may include the humidity, temperature, wind direction and speed, barometric pressure, cloud properties (e.g., height, size, humidity, temperature, size and density of ice crystal or water droplets, etc.). At least one sensor 95 may include a Global Positioning System device configured to measure the location of vehicle 10. At least one sensor 95 may transmit the measured data, including the weather conditions data, to a storage device (e.g., a memory or a data storage drive) for storage, to the processor included in control unit 90 for processing, and/or to a control station via communication unit 80.

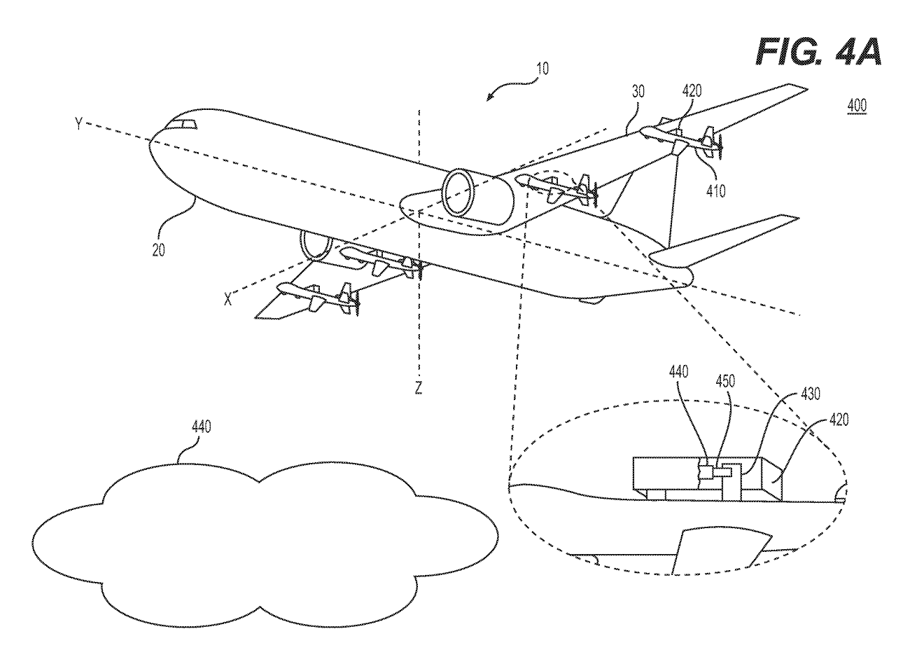

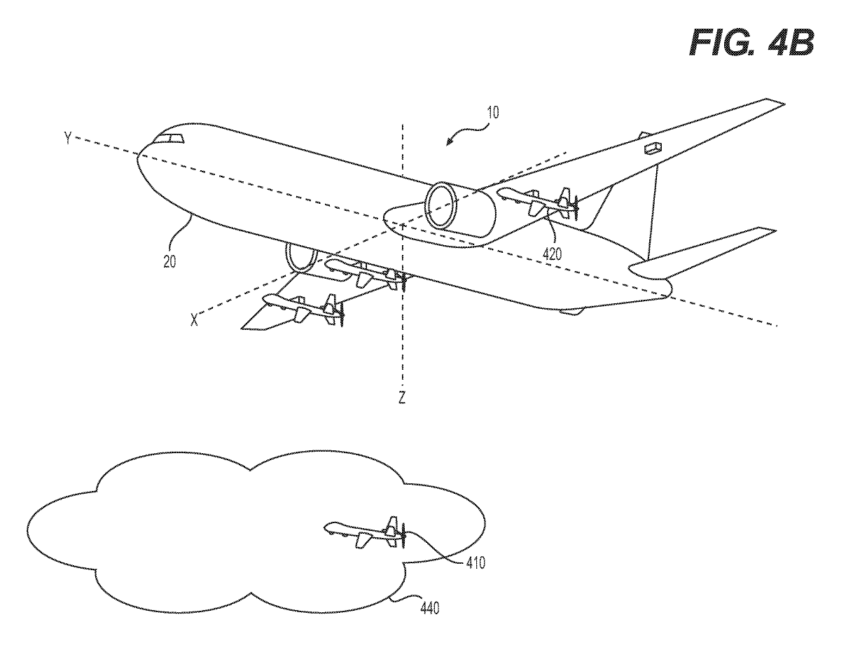

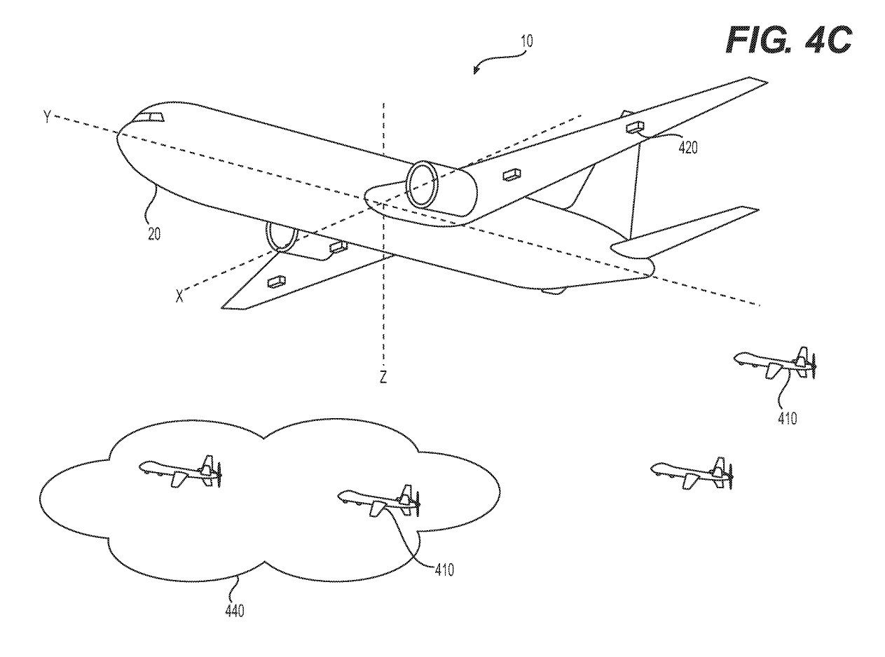

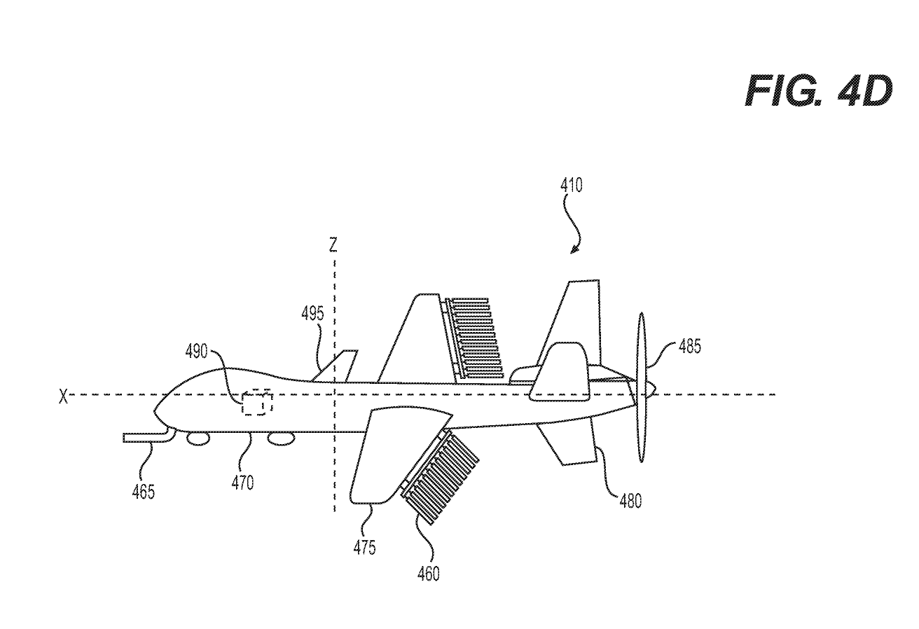

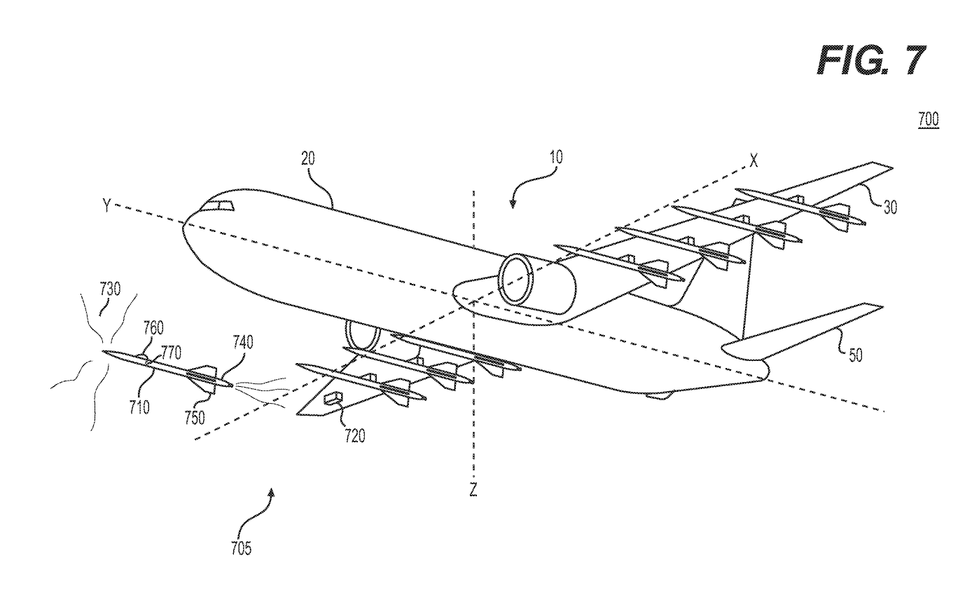

Vehicle 10 may also include at least one auxiliary vehicle attached to at least one of hull 20, at least one wing 30, or at least one tail wing 50. An auxiliary vehicle may be an unmanned aerial vehicle (UAV) (also shown in FIGS. 4A-4D) or a missile (also shown in FIG. 7). The auxiliary vehicles may be detachable or deployable from the vehicle 10 for weather modification operations.

The terms “front” and/or “fore” will be used to refer to areas within a section of vehicle 10 close to forward travel, and the terms “rear” and/or “aft” will be used to refer to areas within a section of vehicle 10 close to the opposite direction of travel.

FIG. 1 further illustrates various axes relative to the vehicle 10 for reference purposes. Vehicle 10 may include a roll axis X, a pitch axis Y, and a yaw axis Z. Roll axis X of vehicle 10 may correspond with an axis running through hull 20 in a direction from, for example, a tail 55 (rear-most point of hull 20) to a nose 70 (forward-most point of hull 20) of vehicle 10. Yaw axis Z of vehicle 10 may be a central, vertical axis corresponding with an axis running perpendicular to roll axis X through hull 20 in a direction from, for example, a bottom surface of hull 20 to a top surface of hull 20. Pitch axis Y may correspond to an axis running perpendicular to both yaw and roll axes, such that pitch axis Y runs through hull 20 from one side of vehicle 10 to the other side of vehicle 10, as shown in FIG. 1. “Roll axis” and “X axis;” “pitch axis” and “Y axis;” and “yaw axis” and “Z axis” may be used interchangeably throughout this discussion to refer to the various axes associated with vehicle 10.

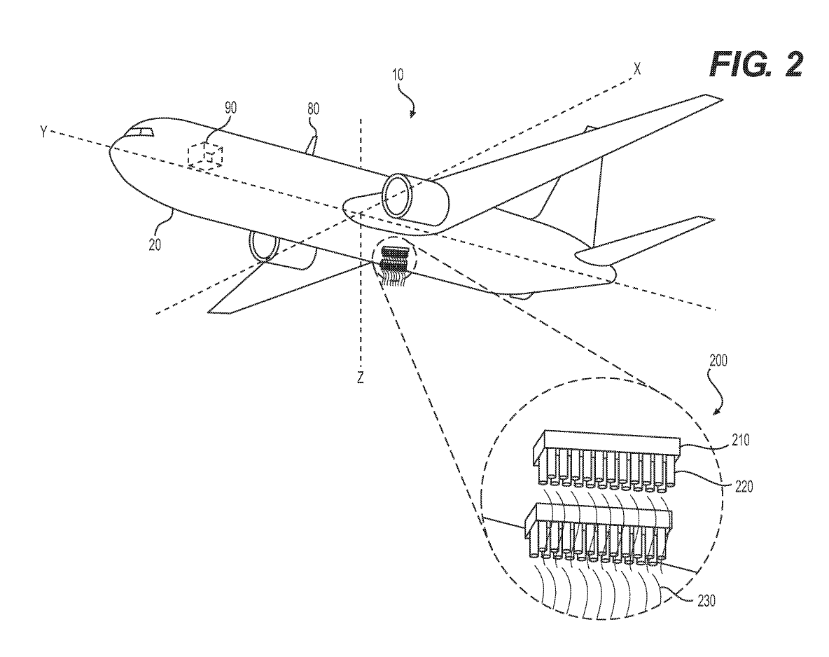

FIG. 2 illustrates an exemplary weather modification system having a flare system 200 for use as a weather modification device 110. As shown, flare system 200 may be attached to hull 20 of vehicle 10. Flare system 200 may also be attached to any other suitable place of vehicle 10, such as at least one wing 30 or at least one tail wing 50. Flare system 200 may include at least one rack 210 configured to store individual flares 220. The at least one rack 210 may be attached to vehicle 10 through any suitable connection mechanisms. For example, at least one rack 210 may be attached to hull 20 by fasteners or to frame members of the support structure of vehicle 20.

Flare system 200 may include multiple flares 220 contained within the at least one rack 210. Flares 220 may be either burn-in-place flares or ejectable flares. Burn-in-place flares 220 may be ignited and burnt while still attached to the at least one rack 210. Ejectable flares 220 may be ejected from the at least one rack 210 and be ignited and burnt at a distance from the vehicle 10 (e.g., adjacent a target cloud 140). Vehicle 10 may also utilize a mixture of different types of flares 220. For example, a first portion of racks 210 may contain burn-in-place flares while a second portion of racks 210 may contain ejectable flares, to allow vehicle 10 to target multiple target clouds 140 at the same time.

Flares 220 may include multiple compositions that are capable of burning to create a dispersant which may induce precipitation in target clouds 140. For example, flares 220 may include at least one of the following compositions: silver iodide, silver oxide, hygroscopic materials, such as table salt. Flares 220 may also include other suitable flare compositions. In some embodiments, flares 220 in separate racks 210 may contain the same or different compositions. For example, the first portion of racks 210 may contain flares 220 with hygroscopic materials and the second portion of racks 210 may contain flares 220 with silver iodides. In this manner vehicle 10 may apply different dispersants by burning different compositions, depending on the weather conditions.

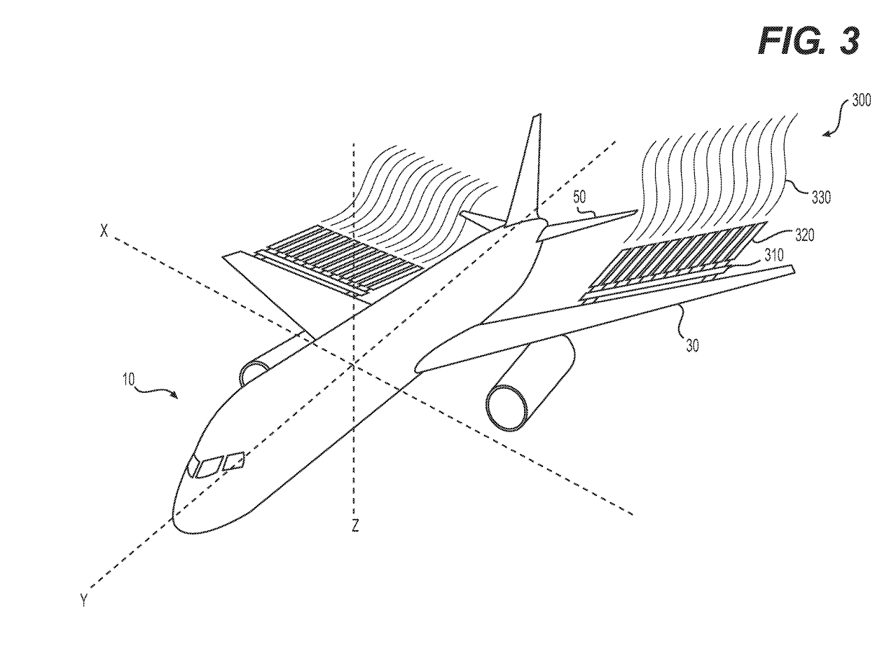

FIG. 3 illustrates an exemplary weather modification system having a flare system 300 for use as a weather modification device 110. In this example, flare system 300 may be attached to at least one wing 30 of vehicle 10. Additionally or alternatively, flare system 300 may be attached to other places of vehicle 10, such as, for example, hull 20 and at least one tail wing 50. Flare system 300 may include at least one flare rack 310 configured to hold individual flares 320. The flares 320 may extend backward (e.g., toward the tail of vehicle 10) from the back end of the at least one flare rack 310. The at least one rack 310 may be attached to the at least one wing 30 through any suitable connection mechanisms. For example, the at least one rack 310 may be attached to the at least one wing 30 by fastening devices, such as screws, or linkages. Additionally or alternatively, the at least one rack 310 may be welded to the wing 30.

Flare system 300 may include multiple flares 320 held by the at least one rack 310. Flares 320 may include at least one of a burn-in-place flare and an ejectable flare. Burn-in-place flares 320 may be ignited and burnt while still attached to the at least one rack 310. Ejectable flares 320 may be ejected from the at least one rack 310 and ignited and burnt at a distance from vehicle 10. Vehicle 10 may also utilize a mixture of different types of flares 320. For example, a first portion of racks 310 may contain burn-in-place flares while a second portion of racks 310 may contain ejectable flares, to allow vehicle 10 to target multiple different target clouds 140 at the same time.

Flares 320 may include multiple compositions that are capable of burning to create a dispersant which may induce precipitation in target clouds 140. For example, flares 320 may include at least one of the following compositions: silver iodide, silver oxide, hygroscopic materials, such as table salt. Flares 320 may also include other suitable flare compositions. Flares 320 in separate racks 310 may contain the same or different compositions. For example, the first portion of racks 310 may contain flares 320 with a hygroscopic material and the second portion of racks 310 may contain flares 320 with silver iodide. In this manner vehicle 10 may apply different dispersants by burning different compositions, depending on the weather conditions.

FIGS. 4A-4D illustrate a weather modification system having auxiliary vehicles.

In the examples shown in FIGS. 4A-4D, the auxiliary vehicles are unmanned aerial vehicles (UAV). For example, FIG. 4A shows a weather modification system 400 having a plurality of UAVs (hence the weather modification system 400 may also be referred to as a UAV weather modification system 400). As shown in FIG. 4A, UAV weather modification system 400 may include at least one UAV 410 (e.g., a plurality of UAVs 410) mounted by a connecting mechanism 420 to vehicle 10. The UAVs 140 may be mounted, attached, or docked to vehicle 10 at any suitable place, such as at least one of hull 20, at least one wing 30, or at least one tail wing 50. Connecting mechanism 420 may allow for the UAVs 410 to be released, detached, or deployed from vehicle 10 to carry our certain tasks, such as weather condition measure tasks or weather modification operations. In some embodiments, connecting mechanism 420 may be attached to the hull 20 of the vehicle 10 or the frame members of the support structure.

FIG. 4A contains a close-up view of connecting mechanism 420. Connecting mechanism 420 is configured to connect at least one UAV 410 to vehicle 10. Each UAV 410 may contain at least one connecting bar, rod, or linkage 430 that is received in connecting mechanism 420. Connecting bar 430 may be held in place by a pin 450. Pin 450 may be actuated by an actuator 440 to move (e.g., withdraw) pin 450 relative to the at least one connecting bar 430. For example, when pin 450 is withdrawn, connecting bar 430 may be released from the connecting mechanism 420 to release, detach, or deploy the UAV 410 from vehicle 10.

During operation UAVs 410 may be selectively released, detached, or deployed from vehicle 10 to perform at least one weather related function. The at least one weather related function includes weather modification, weather monitoring, and coordination between a control station 940 (FIG. 9) and at least one vehicle 10 or other UAVs 410. The operations of the weather modification system 400, including operations of the UAVs 410, are discussed below in reference to FIGS. 9 and 10.

FIGS. 4A-4D further depict the UAV system 400 in operation. FIG. 4A illustrates a group of UAVs 410 attached to vehicle 10 that may be near a target cloud 440, which may be a potential candidate for weather modification by, e.g., cloud seeding. At this point no UAVs 410 have been released from vehicle 10. As shown in FIG. 4B, a UAV 410 has been released from connecting mechanism 420 of vehicle 10 to perform at least one weather related function. For example, UAV 410 may fly to target cloud 440 to perform a weather modification function such as cloud seeding, or to measure or monitor the conditions of target cloud 440. FIG. 4C illustrates multiple UAVs 410 that have been released from vehicle 10 to perform at least one weather related function. Once released, the UAVs 410 may continue to operate until no weather related functions are needed, until the UAVs 410 are no longer capable of performing weather related functions (e.g., run out of fuel or energy), or until the UAVs 410 receive a command to return to a place (e.g., an airport, vehicle 10, etc.) or to abort performing weather related functions. For example, target cloud 440 may dissipate so that weather modification is not possible. UAV 410 may receive a command from vehicle 10 or a control station to abort the weather modification operation.

At the conclusion of the operation cycle, the UAVs 410 may return to a central docking station, such as an airport, and land. Alternatively or additionally, the UAVs 410 may return to vehicle 10 and re-dock at vehicle 10 (e.g., returning to vehicle 10 and be secured to vehicle 10 through connecting mechanism 420). In some embodiments, connecting mechanism 420 may be dedicated to a specific UAV 410 so that the UAV 410 is released and re-docked at the same connecting mechanism 420. Alternatively, the UAVs 410 may be released and re-docked by different connecting mechanism 420. The UAVs 410 may be refueled with fuel, recharged with electricity, and/or reloaded with additional weather modification compositions, for performing further weather related functions. In some embodiments, vehicle 10 may return to the central docking station to be reloaded with additional UAVs 410 for continued weather modification or manipulation.

As shown in FIG. 4D, a UAV 410 may include a hull 470 and at least one wing 475 (e.g., a pair of wings 475) connected to hull 470. UAV 410 may also include at least one sensor 465 configured to measure a parameter associated with navigation of UAV 410, weather condition, or a weather modification operation. Any suitable sensors may be included in UAV 410 to measure the desired parameters. UAV 410 may include at least one propulsion assembly 485 coupled to at least one of hull 470 or at least one wing 475. The propulsion assembly 485 may include any suitable engines, such as a jet engine, a propeller engine, an electric motor powered engine, a hybrid engine, etc. UAV 410 may include at least one control surface 480 configured to control the aerodynamics or flight stability of UAV 410.

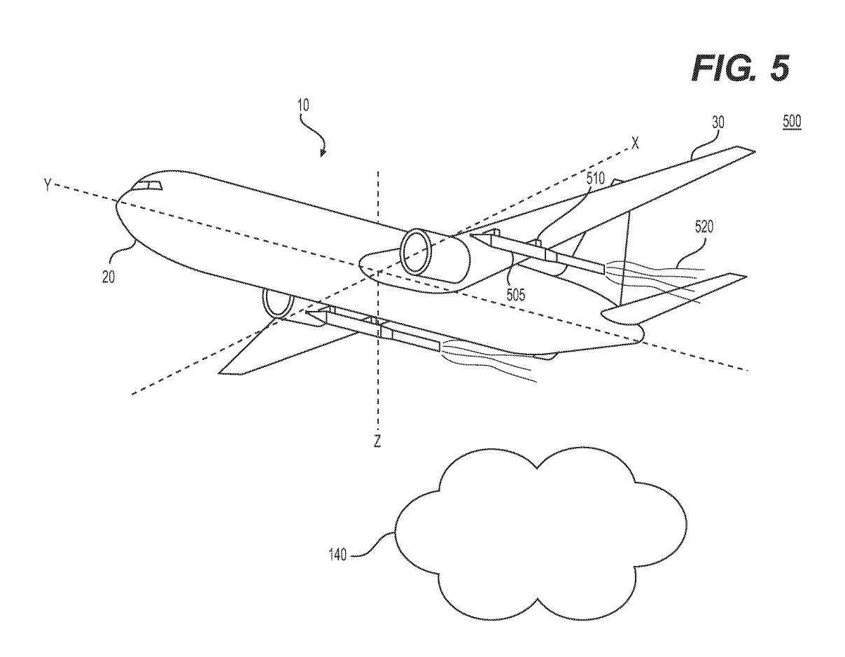

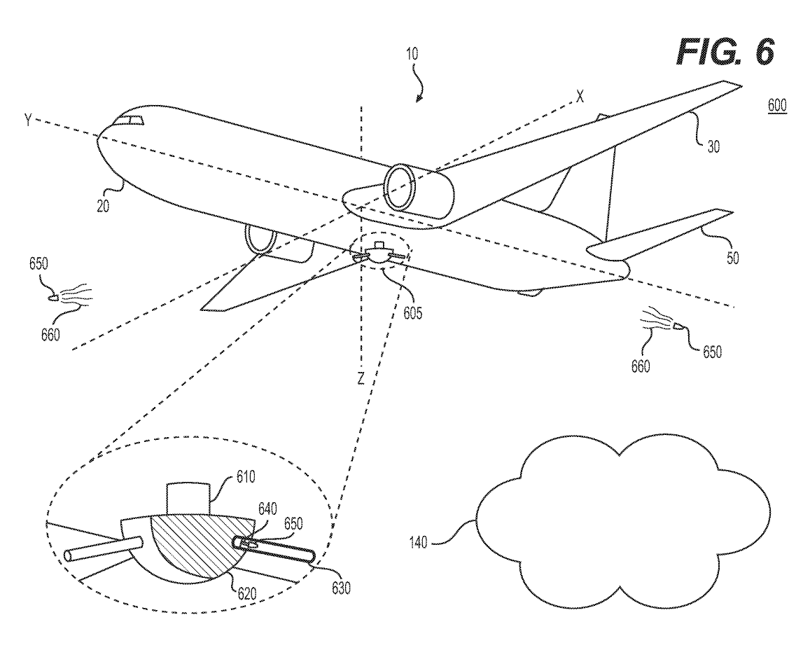

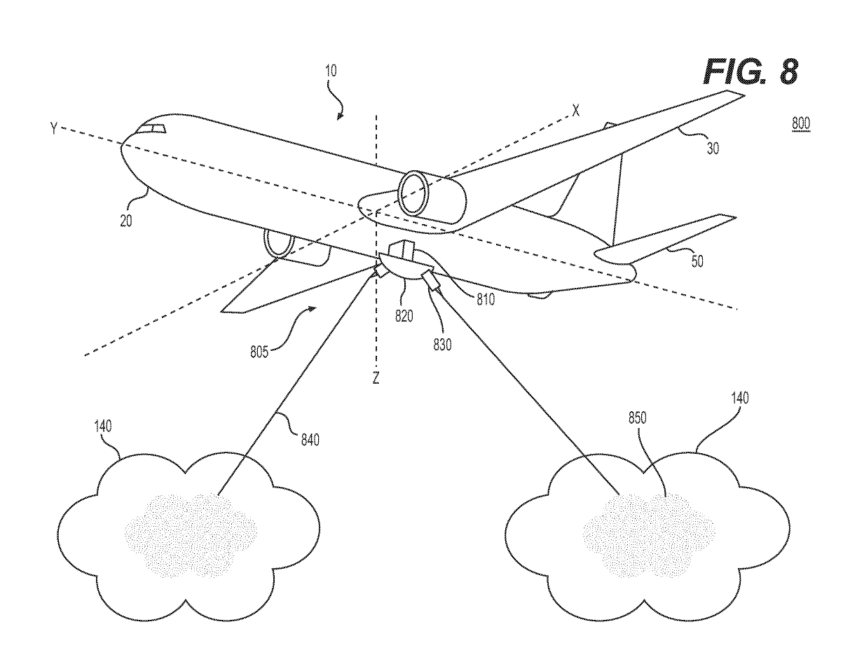

UAV 410 may include a weather modification system 460, which may be at least one of the disclosed weather modification systems including: a flare system (e.g., FIGS. 2-3), a generator (e.g., FIG. 5), a projectile launching system (e.g., FIG. 6), a missile system (e.g., FIG. 7), and a beam emitter system (e.g., FIG. 8). The UAV 410 may also use any of the compositions disclosed herein or any combination of weather modification systems and compositions disclosed herein. In the example UAV 410 shown in FIG. 4D, a flare-based system is used. The weather modification system 460 may be attached to at least one of hull 470 or at least one wing 475.

UAV 410 may also include a control unit 490 configured to control the navigation and weather modification operations of UAV 410. Control unit 490 may also be configured to control communications of UAV 410 with vehicle 10, other UAVs, and/or a control station. Control unit 490 may include a processor for processing data, circuits for processing electrical signals, and/or a memory for storing data. Control unit 490 may communicate with other devices, vehicles, or control stations via a communication device 495. For example, control unit 490 may receive data that may include commands or instructions from vehicle 10 or control stations via communication device 495.

Communication device 495 is configured to communicate with vehicle 10, other UAVs 410, and/or control stations. For example, UAV 410 may measure weather conditions using at least one sensor 495, and may transmit measured weather conditions data to vehicle 10 and/or control station through communication device 495. For example, control unit 490 may receive data (e.g., commands) from vehicle 10 and/or control station through communication device 495. In some embodiments, the data may relate to a weather modification operation, a weather condition measurement or monitoring operation, etc. In some embodiments, the data may include commands or instructions that direct UAV 410 to a certain area to perform a weather related operation, to start or stop weather conditions measurement or monitoring, to start or stop a weather modification operation (e.g., to start or stop generating and/or releasing a dispersant used for cloud seeding). UAV 410 may communicate with other UAVs to exchange information (e.g., positions, weather conditions data, etc.) through communication device 495.

The at least one sensor 465 may be any sensor that measures weather information. In some embodiments, the at least one sensor 465 may be a pitot tube that measures fluid flow velocity. In some embodiments, the at least one sensor 465 may be configured to measure humidity, temperature, location, pressure, cloud properties (e.g., location, height, size, etc.), and radiation. The at least one sensor 465 may communicate with the control unit 490.

FIG. 5 illustrates an exemplary embodiment of a weather modification system 500 having one or more generators for use as a weather modification device 110. The weather modification system 500 may include at least one generator 505 that may be attached to vehicle 10 by any suitable connection mechanism 510. In some embodiments, at least one generator 505 may be attached to any suitable place of vehicle 10. For example, at least one generator 505 may be attached to the wings 30 by connection mechanism 510. Additionally or alternatively, at least one generator 505 may also be attached to tail wing 50 and/or hull 20. Multiple generators 505 may be attached to vehicle 10 at various places of vehicle 10.

During a weather modification operation, at least one generator 505 may be configured to burn a weather modification composition to create a dispersant 520 that is expelled into the atmosphere to induce precipitation in target clouds (e.g., target clouds 140). For example, generator 505 may use at least one of the following compositions: silver iodide, silver oxide, hygroscopic materials, such as table salt, or liquid propane. Generator 505 may also use other suitable generator compositions. Generator 505 may use propane or any other suitable catalyst to burn the weather modification composition to create dispersant 520. In some embodiments, vehicle 10 may contain multiple generators 505 that use different weather modification compositions from each other. For example, one generator 505 may use a hygroscopic composition and another generator 505 may use a silver iodide composition. Additionally or alternatively, a single generator 505 may use multiple different compositions contained in different storage tanks on vehicle 10, such that different dispersant 520 may be generated using different compositions by single generator 505. Selection of the different compositions may be based on weather conditions, conditions of the target cloud, desired amount of precipitation, types of precipitation (e.g., rain or snow fall), etc. A control station or vehicle 10 (e.g., via the onboard control unit) may be configured to select the suitable composition, and may send a signal to the single generator 505 to use the selected composition.

Additional types of generators 505 may also be used with vehicle 10 for weather modification or manipulation. For example, an atomizer may be included in vehicle 10, which may use a composition such as silver iodide to saturate a fluid to generate a dispersant that is exhausted into the atmosphere.

FIG. 6 illustrates an exemplary embodiment of a weather modification system 600 having a projectile launching system for use as a weather modification device 110. The projectile launching system includes at least one projectile launcher 605 that is attached to vehicle 10 by a suitable connection mechanism 610. In some embodiments, at least one projectile launcher 605 may be attached to any suitable place of vehicle 10. For example, at least one projectile launcher 605 may be attached to the wings 30 by connection mechanism 610. Additionally or alternatively, at least one projectile launcher 605 may be attached to tail wing 50 or hull 20 through connection mechanism 610. Multiple projectile launchers 605 may be attached to vehicle 10 at various places through connection mechanism 610.

FIG. 6 includes a close-up view of projectile launcher 605. The close-up view illustrates projectile launcher 605 as a turret-like device. Projectile launcher 605 may include a housing 620 that may be connected to vehicle 10 through connection mechanism 610. In some embodiments, connection mechanism 610 may connect projectile launcher 605 to hull 20. In some embodiments, projectile launcher 605 may be attached to the frame members of the support structure of vehicle 10 through connection mechanism 610. Housing 620 may include at least one barrel 630 configured for directing projectiles 650. Housing 620 may be capable of pivoting (along the X-axis and/or Y-axis), rotating (along the Z-axis) or any combination thereof so that barrels 630 may be aimed in any direction. Housing 620 and at least one barrel 630 may form a system that is capable of launching at least one projectile 650 from barrel 630. The at least one projectile 650 may be similar to a gun or cannon shell, and may contain a propellant that may be triggered by a firing pin 640 contained in housing 620. The projectile launcher 605 may also use alternative means for expelling projectiles 650 using expanding gas such as compressed air. Additionally, projectile 650 may contain a composition that may be used to create a dispersant 660 that is spread into the atmosphere when projectile 650 is launched from housing 620.

Projectiles 650 may be constructed to spread dispersant 660 after being launched. Projectiles 650 may use at least one of the following compositions to generate dispersants 660: liquid carbon dioxide, dry ice, silver iodide, silver oxide, hygroscopic materials such as table salt, and hydrophilic sodium alginate. Projectiles 650 may also use other suitable materials. In operation, dispersant 660 is released from projectile 650 after projectile 650 is launched from barrel 630. In some embodiments, projectile 650 may include metering holes on the back end or sides of projectile 650. The metering holes may allow dispersant 660 to leave projectile 650 in a controlled manner. In some embodiments, the composition may burn within projectile 650 to create dispersant 660 that is emitted into the atmosphere. In some embodiments, projectile 650 may contain an explosive charge that may detonate projectile 650 once projectile 650 has traveled a specified distance. This type of projectile 650 may spread dispersant 660 after detonation, for example, when projectile 650 is within a specified distance of a target cloud 140.

Vehicle 10 may include multiple different types of projectiles 650 that may contain the same or different compositions. For example, vehicle 10 may select the type of projectile 650 and the type of composition based on weather conditions, the type of target cloud 140, conditions of the target cloud, desired amount and type of precipitation to be generated, etc. Vehicle 10 may then fire the selected projectile 650 into the target clouds to create precipitation. Vehicle 10 may also select a range of different projectiles 650 that contain different compositions to enhance the possibility of creating precipitation.

In operation the at least one projectile 650 may be launched using firing pin 640 contained in housing 620. Firing pin 640 may contact projectile 650 and activate the propellant in projectile 650. After firing pin 640 activates the propellant, projectile 650 is expelled from barrel 630 towards a target, such as a target cloud 140. For example, at least one barrel 630 may aim at target cloud 140 and send projectiles 650 to various parts of target cloud 140. In this manner projectiles 650 may spread dispersant 660 to a larger area in target cloud 140. In addition, barrel 630 may aim at multiple target clouds 140 and launch projectiles 650 at multiple target clouds 140 in short succession. In this manner vehicle 10 may spread a large amount of dispersant to multiple target clouds 140 without having to navigate to each individual cloud.

FIG. 7 illustrates an exemplary embodiment of a weather modification system 700 having a missile launching system 705 for use as a weather modification device 110. Missile launching system 705 may include a connection apparatus 720 configured to connect at least one missile 710 to vehicle 10. The at least one missile 710 may be attached to vehicle 10 by any suitable connection mechanism 720. The at least one missile 710 may also be attached to any suitable place of vehicle 10. For example, at least one missile 710 may be attached to wings 30 by connection mechanism 720. Additionally or alternatively, at least one missile 710 may be attached to tail wing 50 and/or hull 20. Multiple missiles 710 may be attached to vehicle 10 at various places of vehicle 10.

Missiles 710 may be constructed in any suitable manner to spread dispersant 730 during flight. For example, missile 710 may include a composition that burns to form a dispersant 730 that is released through vents or metering holes on the body of missile 710. Missile 710 may use at least one of the following compositions to create a dispersant 730: silver iodide, silver oxide, hygroscopic materials such as table salt. Missile 710 may also use other suitable compositions. In some embodiments, missile 710 may detonate and spread dispersant 730 into a target cloud upon detonation.

Missiles 710 may be powered by a motor 740. Motor 740, for example, may include a rocket booster that burns a material to power missile 710. Missile 710 also may include control surfaces 750, such as vanes or fins, that may alter the course of missile 710 during powered or unpowered flight. Missile 710 may be directed to a desired target cloud during flight by control surfaces 750. Missiles 710 may also contain a landing apparatus such as a parachute that may be deployed to assist missile 710 in landing on the ground. In some embodiments, missile 710 may be capable of being recycled and reused since the user may recover missile 710 and re-load the missile for later use. In some embodiments, missile 710 may be configured for one time use, and may not be recycled after it is launched.

Missiles 710 may also include a communication device 760 and a control unit 770. In some embodiments, communication device 760 is any device that is configured to communicate with other communication devices, other vehicles, other missiles, or a control station by transmitting and receiving signals. Control unit 770 is any device that is configured to control missile 710, such as the flight of missile 710, the timing and amount of dispersant to be generated and released. Control unit 770 may also be configured to process signals received from other vehicles, missiles, or control station, or generate and transmit signals to other vehicles, missiles, or control station. For example, control unit 770 may include a processor configured to process data or signals, circuits configured to process electrical signals, and a memory configured to store data.

Missile launching system 705 may operate in the following exemplary manner. First, missile launching system 705 may receive a command from vehicle 10 to initiate a missile launch. Then missile 710 is released from vehicle 10 and motor 740 is initiated. Missile 710 is then guided to a target cloud by control unit 770 and control surfaces 750 and begins releasing dispersant 730. After missile 710 has released dispersant 730, missile 710 may be guided to the ground. Missile 710 may release a parachute to help missile 710 with safe landing on the ground. Any other suitable method or apparatus may be used to guide missile 710 to the ground.

FIG. 8 illustrates an exemplary embodiment of a weather modification system 800 having a beam emission (or beam emitter) system 805 for use as a weather modification device 110. Beam emission system 805 may be attached to the vehicle 10 by any suitable connection mechanism 810 at any suitable place of vehicle 10. For example, beam emission system 805 may be attached to wings 30 by connection mechanism 810. Additionally or alternatively, beam emission system 805 may be attached to tail wing 50 and/or hull 20. Multiple beam emission systems 805 may be attached to vehicle 10 at various places of vehicle 10.

In some embodiments, beam emission system 805 may be a turret-like device. Other suitable beam emission systems may also be used. Beam emission system 805 may include a housing 820. Connection mechanism 810 may be configured to connect housing 820 to vehicle 10. In some embodiments, beam emission system 805 may be attached to the frame members of the support structure of vehicle 10 through connection mechanism 810. Housing 820 may include at least one beam emitter 830 configured to generate and emit a beam 840. Housing 820 may be capable of pivoting (along the X-axis and/or Y-axis), rotating (along the Z-axis), or any combination thereof so that at least one beam emitter 830 may be aimed in any direction. Housing 820 and at least one beam emitter 830 may form a system that is capable of generating and emitting at least one beam 840 from emitter 830.

The at least one beam 840 may be a charged ion beam, an electron beam, or a positron beam. Beam emitter 830 may generate beam 840 and emitted beam 840 toward a target cloud 140. Once beam 840 reaches target cloud 140, beam 840 may facilitate creation of precipitation within target cloud 140. For example, a charged ion beam 840 may create charged particles 850 in target cloud 140 through the deposition of energy into the cloud. If charged ion beam 840 remains on target cloud 140 and continues to deposit charged particles 850, precipitation may begin to form. The precipitation may form rain or snow, for example, and fall from target cloud 140 to ground.

Vehicle 10 may include multiple different types of beam emitters 830 that may generate different beams 840. For example, vehicle 10 may select (e.g., by an onboard control unit) a type of beam 840 based on the type and/or conditions of target cloud 140 such that the selected beam 840 may work best with that specific target cloud. Vehicle 10 may determine, for example in association with a control station, where to aim beam 840 in target cloud 140. Beam emission system 805 may direct beam 840 to the aimed location.

In a weather modification operation, at least one beam 840 may be generated by beam emitter 830. Beam emitter 830 may emit beam 840 at a specific target cloud 140. For example, at least one beam emitter 830 may aim at a single target cloud 140 and emit beams 840 to various parts of the target cloud 140. In this manner beams 840 may spread charged particles 850 to a larger area in target cloud 140. In some embodiments, at least one beam emitter 830 may aim at multiple target clouds 140 and emit beams 840 toward multiple target clouds 140. In this manner vehicle 10 may spread a large amount of charged particles 850 to multiple target clouds 140 without having to navigate to each individual cloud.

FIG. 9 illustrates an exemplary embodiment of a system for weather modification including a control system. As shown in FIG. 9, a system 900 for weather modification may include multiple different vehicles 905, 910, and 920. Each of vehicles 905, 910, and 920 may be one of vehicles 10 disclosed in other embodiments (e.g., those shown in FIGS. 1-8 and 11). System 900 may also include an auxiliary vehicle 930 deployed from one of vehicles 905, 910, and 920. Each of vehicles 905, 910, 920, and auxiliary vehicle 930 may be a UAV, an airship, such as a lenticular airship, a balloon, a helicopter, or a lighter than air vehicle.

As shown in FIG. 9, the system 900 for weather modification may include a control station or system 940. Control station 940 may be used as the control station discussed above or below in other embodiments. Control station 940 is configured to perform various control functions. In some embodiments, control station 940 may monitor the operation status of vehicles (e.g., vehicles 10 and auxiliary vehicles) and control the deployment and/or the weather modification operations of the vehicles. The operation status of vehicles may include at least one of status related to the condition of the vehicle, status related to the condition of the auxiliary vehicle, status related to the operation of the solar panel, status of a cloud seeding operation, an amount of fuel in the vehicle, an amount of the at least one weather modification composition, and weather information detected or measure by sensors installed on the vehicles.

Control station 940 may include a processor 960 and a communication device 965. Communication device 965 may be any suitable communication device, e.g., an antenna, a signal transmitting tower, etc., configured to communicate with other devices, vehicles, or control stations (when multiple control stations are used). Processor 960 may be any suitable processor configured to process signals or data received from the vehicles deployed in the air. Processor 960 may be configured to analyze weather information, and send signals (e.g., commands) to the vehicles to adjust weather modification operations conducted by the vehicles based on the analysis of weather information. Control station 940 may receive weather information measured by the vehicles (e.g., by sensors 95 on vehicle 10) in near real time via communication device 965. For example, the vehicles may send weather information periodically within a predetermined time interval, such as every 1 minute, 5 minutes, 10 minutes, 30 minutes, 1 hour, etc. Additionally or alternatively, the predetermined time interval may be altered in response to different weather conditions. For example, the predetermined time interval may be shortened when prime weather modification conditions are present. Alternatively or additionally, the predetermined time interval may be lengthened when the weather conditions are not suitable for weather modification.

Control station 940 may be configured to control the location and operation of the vehicles (e.g., 900, 910, 920, 930). For example, control station 940 may determine where a vehicle (including auxiliary vehicle) should be deployed, the number of vehicles to be deployed in a certain area, when a vehicle should start weather modification operation, when a vehicle should stop a weather modification operation, the amount and timing a dispersant should be generated and released to a target cloud. Control station 940 may also control weather measurement and monitoring conducted by a vehicle (e.g., vehicle 10 or auxiliary vehicle 410). Control station 940 may monitor for weather information using independent instruments or sensors placed on a vehicle deployed in the sky, to determine target clouds 140 and areas where potential target clouds 140 may form. For example, based on weather information received from vehicle 10, 905, 910, and 920, and/or auxiliary vehicle 410, control station 940 may determine a target cloud for cloud seeding, a timing for cloud seeding, and an amount of dispersant to be generated and released for seeding the target cloud. In some embodiments, control station 940 may instruct multiple UAVs 410 to measure weather information around a vehicle 10 to determine suitable locations for vehicle 10 to modify or manipulate weather.

In some embodiments, control station 940 may alter the weather modification operations of some vehicles, such as by decreasing or increasing the amount of dispersant released, and by instructing vehicles to start or termination weather modification operations. Control station 940 may communicate, through communication device 965 included in control station 940, with vehicles (e.g., 10, 410, 905, 910, 920, and 930) to determine if the vehicles need to land for refueling, servicing or re-equipping. For example, control station 940 may determine that the weather modification device 110 on a specific vehicle needs to be repaired and may direct the vehicle to land in a service center for servicing. In some embodiments, control station 940 may control the number of vehicles 10 deployed in the air. For example, if prime weather conditions are present, control station 940 may send additional vehicles (e.g., vehicles 10) to a specific area to take advantage of the beneficial weather conditions. Control station 940 may also direct a group of vehicles to disperse to different locations to take advantage of weather conditions across a larger area.

Although control station 940 is shown in FIG. 9 as a ground-based control station, it may alternatively be a sea-based control station or an air-based control station. Multiple control stations (e.g., ground-based, sea-based, and air-based) may be used. In some embodiments, control station 940 may communicate with a single vehicle that acts as an aerial command station. For example, airplane 905 may act as an aerial command station. In FIG. 9, airplane 905 may communicate with control station 940 and other vehicles (e.g., 910, 920, and 930) through wireless communications, as indicated by lines 950. Airplane 905 may function as an aerial command station by routing commands received from control station 940 to other vehicles (e.g., 910, 920, and 930). Alternatively or additionally, airplane 905 may monitor vehicles 910, 920, and 930 and generate commands without communicating with command station 940. Command station 940 and a vehicle acting as an aerial command station may perform multiple other functions.

FIG. 10 illustrates an exemplary embodiment of a command center 1000 for the weather modification system. Command center 1000 include or otherwise be associated with control station 940. As shown in FIG. 10, command center 1000 may include at least one computer server 1010, at least one screen or display 1020 configured to display data and/or at least one digital map 1030. In some embodiments, digital map 1030 may be displayed on a dedicated screen or display to show the distribution of vehicles (e.g., 10, 410, 905, 910, 920, 930, etc.). In some embodiments, digital map 1030 may be displayed on a same screen or display as other data, such as weather information. The command center 1000 may communicate with the vehicles (e.g., 10, 905, 910, 920, and 930) through a suitable communication device (e.g., communication device 965 included in the control station 940 or any other communication device).

Computer server 1010 may be configured to carry out functions of command center 1000. Computer server 1010 may be any suitable computer system that allows a user or operator to interact with command center 1000. For example, computer server 1010 may include one or more computers that contain an operating system, such as LINUX, iOS, UNIX, OS X, WINDOWS, at least one processor, at least one data storage device, such as a hard disk and/or at least one memory (transitory and/or non-transitory memories). Computer server 1010 may be configured to interact with the vehicles (e.g., vehicle 10 and/or auxiliary vehicles, such as UAV 410) to control the flight and/or weather modification operations of these vehicles. For example, a user may use computer server 1010 to direct a vehicle 10 to return to a service area (e.g., by sending a command signal to vehicle 10 to initiate and control the return of the vehicle 10 to the service area). In some embodiments, a user may direct a vehicle to a specific target cloud 140 using computer server 1010 by sending flight control signals to the vehicle. Computer server 1010 may be configured to process data to determine the next process or function to be performed by the vehicles. Additionally or alternatively, computer server 1010 may be automated so that the vehicles (e.g., vehicles 10, 410, 905, 910, 920, and 930) receive instructions based off of stored commands associated with specific measured inputs.

The at least one screen 1020 may display various information to users of command center 1000. In some embodiments, the screen 1020 may display information about each vehicle (e.g. vehicles 10, 410, 905, 910, 920, and 930) in the air and its current status (e.g., status related to flight and weather modification operations). In some embodiments, screen 1020 may display weather patterns or weather models to allow a user to direct vehicles to the target locations. Screen 1020 may include any type of display that is suitable for displaying data or information (e.g., images, text, video, etc.), such as an LED, CRT or LCD touchscreen or non-touch screen.

The at least one map 1030 may display various vehicles in a specific area. The at least one map 1030 may show different areas. For example, in FIG. 10, map 1030 is illustrated as containing four vehicles 10 distributed along the northwestern United States and southwestern Canada. In some embodiments, map 1030 may also show an icon representing control station 940. In the map, communication lines 1040 may be shown between the icon representing control station 940 and vehicles 10 to illustrate the status of communication connections. In FIG. 10, vehicles 10 are shown as airplanes that are distributed across different areas on map 1030. As shown in FIG. 10, command center 1000 may set specific patrol areas 1050 where vehicles 10 may be deployed while in the air. In this manner, map 1030 shows where each vehicle 10 is operating and allows a user to alter the patrol area 1050 where the vehicles 10 operate. In some embodiments, the user may define a patrol area on map 1030 by, e.g., drawing a circle or any other shape on map 1030. In some embodiments, the user may alter an existing patrol area on map 1030 by, e.g., re-sizing or changing a shape on map 1030 representing the existing patrol area using a suitable input means (e.g., a finger, a mouse, a keyboard).

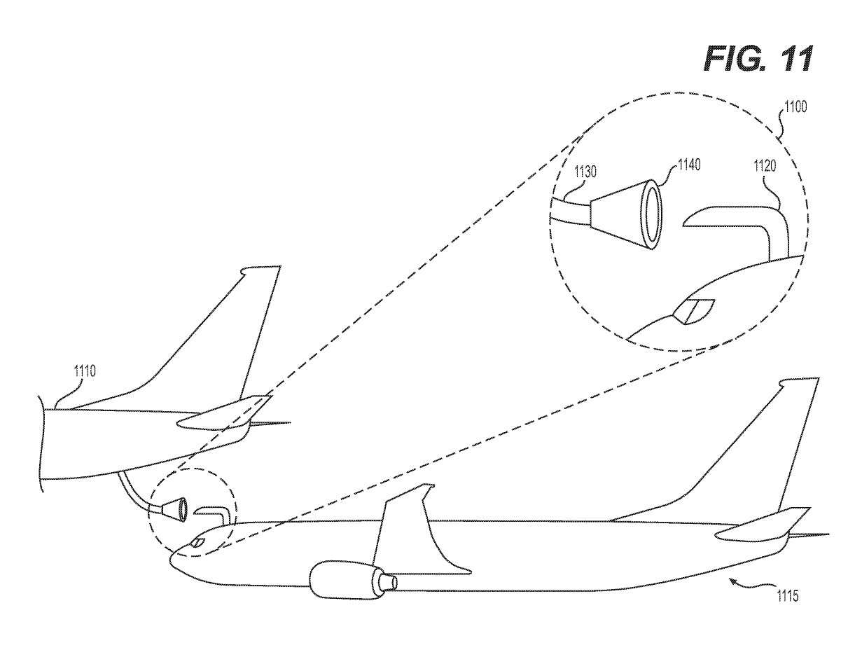

FIG. 11 illustrates an exemplary transfer device 1100 used in a weather modification system according to some embodiments of the present disclosure. Transfer device 1100 may be used to transfer fuel, weather modification composition, or other materials to a vehicle that is deployed in the air for performing weather modification operations or related functions (e.g., weather condition monitoring), such that the vehicle deployed for weather modification operations can continue to operate without returning to the ground for receiving additional fuel or weather modification compositions. As a result, continuous or prolonged weather modification operations can be carried out.

As shown in FIG. 11, transfer device 1100 may include a drogue 1140 attached to a transfer vehicle 1110 (e.g., vehicle 10, 410, 905, 910, 920, and 930) through a hose 1130. Transfer device 1100 may also include a probe or hose 1120 attached to a receiving vehicle 1115 (e.g., 10, 410, 905, 910, 920, and 930) that is configured to receive fuel and/or weather modification compositions. Transfer vehicle 1110 may be a vehicle 10 that is deployed for weather modification operations, a dedicated vehicle for supplying fuel and/or weather modification compositions to vehicles deployed in the air, or auxiliary vehicle 410. For example, transfer vehicle 1110 may be a vehicle 10 deployed for weather modification operations, which may supply fuel and/or weather modification compositions to an auxiliary vehicle 410 (the receiving vehicle 1115). As another example, transfer vehicle 1110 may be a dedicated vehicle for supplying fuel and/or weather modification compositions to a vehicle 10 (receiving vehicle 1115) or an auxiliary vehicle 410 (receiving vehicle 1115). In some embodiments, a first vehicle 10 deployed for weather modification operations may function as transfer vehicle 1110 to supply fuel and/or weather modification compositions to a second vehicle 10 (functioning as receiving vehicle 1115). In some embodiments, a first auxiliary vehicle 410 deployed for weather modification operations may function as transfer vehicle 1110 to supply fuel and/or weather modification compositions to a second auxiliary vehicle 410 (functioning as receiving vehicle 1115).

Probe 1120 may be a retractable device that is configured to deploy during transfer of material (e.g., fuel and/or weather modification compositions) between vehicles. Transfer device 1100 may deliver fuel, lifting gasses, and/or weather modification compositions to receiving vehicle 1115 from the transfer vehicle 1110. Transfer device 1100 may be used when receiving vehicle 1115 is in flight or when receiving vehicle 1115 is docked at a docking station. Transfer device 1100 may be utilized during operation of receiving vehicle 1115 to keep receiving vehicle 1115 in the air and ready to perform weather modification operations continuously. In this manner, transfer vehicle 1110 may be deployed by control station 940 to assist receiving vehicle 1115 by providing necessary supplies.

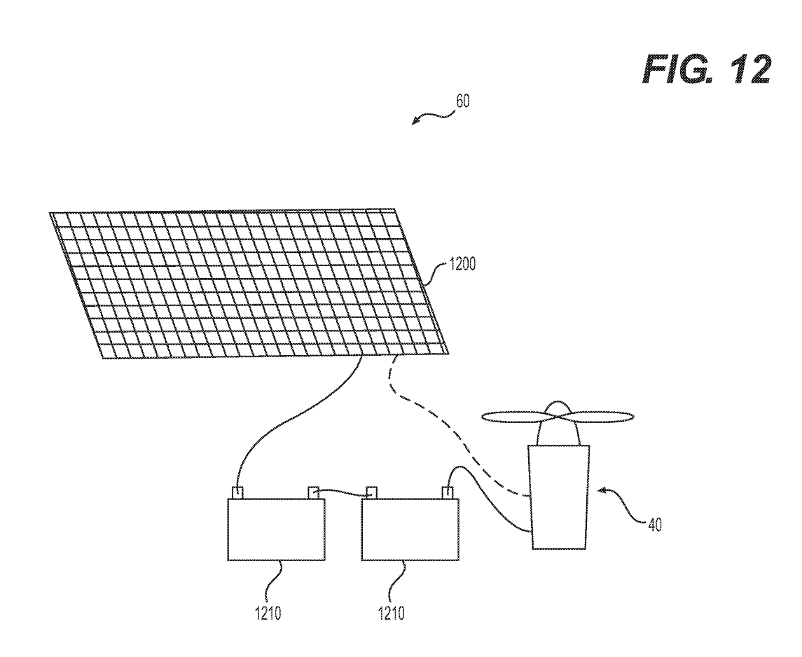

As shown in FIG. 1, vehicle 10 may include a solar power supply system 60. As illustrated in FIG. 12, solar power supply system 60 may include one or more solar panels 1200. Solar panels 1200 may be disposed on various surface places of vehicle 10 in a variety of different configurations. For example, solar panels 1200 may be disposed on at least one of hull 20, wings 30, and tail wing 50. In some embodiments solar panels 1200 may cover substantially all of the upper surfaces of vehicle 10. Solar panels 1200 may convert solar energy into electricity, which may be used for powering electronics on vehicle 10.

Solar panels 1200 may include any suitable photovoltaic cells. Solar panels 1200 may be operatively coupled to the at least one propulsion assembly 40, such as an electric motor included in the propulsion assembly 40. Solar panels 1200 may be configured to supply power to drive the one or more propulsion assembly 40. In some embodiments, solar power supply system 60 may include one or more batteries 1210 operatively coupled to solar panels 1200 and configured to receive and store electrical energy supplied by solar panels 1200. In some embodiments, sufficient electricity may be generated by solar panels 1200 for powering the at least one propulsion assembly 40 and other devices on vehicle 10 for continuous flight and weather modification operations. In some embodiments, when electricity stored in batteries 1210 falls below a threshold, vehicle 10 may be flown to an area above cloud cover to receive stronger sunlight for generating more electricity, and for recharging batteries 1210.

Batteries 1210 may be located within hull 20 of vehicle 10. In addition, various lightweight battery technologies may be employed to minimize any reduction in vehicle performance due to the added weight of batteries.

In some embodiments, the vehicle 10 may run exclusively on solar power from solar panels 1200. For example, when vehicle 10 is exposed to sunlight and/or during certain operations that do not require large amounts of power, vehicle 10 may run exclusively on solar power using solar panels 1200. Electrical energy converted from sunlight by solar panels 1200 may also be used to charge batteries 1210. For example, vehicle 10 may operate at very high altitudes above the majority of cloud cover. In this instance, vehicle 10 may be exposed to almost continuous sunlight during day time that allows for peak solar power production.

Although, for purposes of this disclosure, certain disclosed features are shown in some figures but not in others, it is contemplated that, to the extent possible, the various features disclosed herein may be implemented by each of the disclosed, exemplary embodiments. Accordingly, differing features disclosed herein are not to be interpreted as being mutually exclusive to different embodiments unless explicitly specified herein or such mutual exclusivity is readily understood, by one of ordinary skill in the art, to be inherent in view of the nature of the given features.

While the presently disclosed devices and systems have been described with reference to the specific embodiments thereof, it should be understood by those skilled in the art that various changes may be made and equivalents may be substituted without departing from the scope of the disclosure. In addition, many modifications may be made to adapt a particular situation, material, composition of matter, process, process step, or steps to the objective, spirit, and scope of the present invention. Other embodiments of the invention will be apparent to those skilled in the art from consideration of the specification and practice of the invention disclosed herein. It is intended that the specification and examples be considered as exemplary only.

What is claimed is:

1. A weather modification vehicle, comprising:
a hull;
at least one wing connected to the hull;
at least one weather modification device attached to at least one of the hull and the at least one wing and configured to generate a dispersant for modifying weather using at least one weather modification composition; and
a solar panel installed on a surface of at least one of the hull and the at least one wing and configured to generate electricity from solar energy.

2. The weather modification vehicle of claim 1, wherein the at least one weather modification device is configured to burn the at least one weather modification composition to generate the dispersant that is spread to a cloud for cloud seeding.

3. The weather modification vehicle of claim 1, wherein the at least one weather modification device is configured to eject or release the at least one weather modification composition to generate the dispersant that is spread to a cloud for cloud seeding.

4. The weather modification vehicle of claim 1, further comprising at least one propulsion assembly.

5. The weather modification vehicle of claim 4, wherein the solar panel is configured to generate electricity from solar energy for powering the at least one propulsion assembly.

6. The weather modification vehicle of claim 1, wherein the at least one weather modification device includes at least one of a flare, a generator, an unmanned aerial vehicle, a projectile launcher, and a beam emitter.

7. The weather modification vehicle of claim 1, wherein the at least one weather modification composition includes at least one of silver iodide, hydrophilic sodium alginate, silver oxide, hygroscopic particle, dry ice, liquid propane, and a beam emission.

8. The weather modification vehicle of claim 1, wherein the weather modification vehicle is an airplane.

9. The weather modification vehicle of claim 8, further comprising a conduit configured to connect to a drogue on another aircraft to receive a supply of fuel or the at least one weather modification composition.

10. The weather modification vehicle of claim 1, further comprising:
an auxiliary vehicle attached to at least one of the hull and the at least one wing, the auxiliary vehicle carrying a second weather modification composition for modifying weather, and the auxiliary vehicle being deployable from at least one of the hull and the at least one wing.

11. A weather modification vehicle, comprising:
a hull;
at least one wing connected to the hull; and
an auxiliary vehicle attached to at least one of the hull and the at least one wing, the auxiliary vehicle carrying a weather modification composition for modifying weather, and the auxiliary vehicle being deployable from the at least one of the hull and the at least one wing.

12. The weather modification vehicle of claim 11, wherein the auxiliary vehicle includes at least one control surface configured for controlling the flight of the auxiliary vehicle.

13. The weather modification vehicle of claim 11, further comprising a communication device configured to communicate with the auxiliary vehicle.

14. The weather modification vehicle of claim 13, further comprising a control unit configured to send a signal, through the communication device, to the auxiliary vehicle to control the flight of the auxiliary vehicle.

15. The weather modification vehicle of claim 14, wherein the control unit is further configured to send a signal to the auxiliary vehicle after it is detached from the weather modification vehicle for performing weather modification operations, to control the auxiliary vehicle to return back to the weather modification vehicle and dock to the weather modification vehicle.

16. The weather modification vehicle of claim 13, wherein the weather modification vehicle is configured to send a signal, through the communication device, to the auxiliary vehicle to control the generation of the dispersant using the weather modification composition for cloud seeding.

17. The weather modification vehicle of claim 16, wherein the weather modification vehicle is configured to send the signal to the auxiliary vehicle to control at least one of a timing of generating and releasing the dispersant for cloud seeding and an amount of dispersant to be generated and released.

18. The weather modification vehicle of claim 13, wherein the communication device is further configured to communicate with a control station.

19. The weather modification vehicle of claim 18, wherein the control station is ground-based, sea-based, or air-based.

20. The weather modification vehicle of claim 18, wherein the communication device is configured to receive commands that control the flight and cloud seeding operation of the weather modification vehicle from the control station.

21. The weather modification vehicle of claim 11, further comprising a solar panel installed on a surface of at least one of the hull and the at least one wing.

22. The weather modification vehicle of claim 21, further comprising at least one propulsion assembly, wherein the solar panel is configured to generate electricity from solar energy for powering the at least one propulsion assembly.

23. The weather modification vehicle of claim 11, wherein the at least one weather modification composition includes at least one of silver iodide, hydrophilic sodium alginate, silver oxide, hygroscopic particle, dry ice, liquid propane, and a beam emission.

24. The weather modification vehicle of claim 11, wherein the auxiliary vehicle is configured to generate a dispersant using the at least one weather modification composition for cloud seeding.

25. The weather modification vehicle of claim 11, wherein the weather modification vehicle is an airplane.

26. The weather modification vehicle of claim 25, further comprising a probe configured to connect to a drogue on another aircraft to receive a supply of fuel or the at least one weather modification composition.

27. The weather modification vehicle of claim 11, wherein the auxiliary vehicle includes a communication device configured to communicate with at least one of the weather modification vehicle and a control station.

28. The weather modification vehicle of claim 11, further comprising:
at least one weather modification device attached to at least one of the hull and the at least one wing and configured to generate a dispersant for cloud seeding using at least one weather modification composition.

29. The weather modification vehicle of claim 11, wherein the vehicle is a remote-controlled aircraft.

30. The weather modification vehicle of claim 11, further comprising:
at least one weather modification device attached to at least one of the hull and the at least one wing and configured to generate a dispersant for modifying weather using at least one weather modification composition

31. The weather modification vehicle of claim 11, further comprising:
a solar panel installed on a surface of at least one of the hull and the at least one wing and configured to generate electricity from solar energy.

32. A system for weather modification, comprising:
a plurality of weather modification vehicles deployable in the air, each vehicle comprising:
a hull;
at least one wing connected to the hull;
at least one weather modification device attached to at least one of the hull and the at least one wing and configured to generate a dispersant for modifying weather using at least one weather modification composition; and
a solar panel installed on a surface of at least one of the hull and the at least one wing and configured to generate electricity from solar energy; and
a control station configured to control the operation of the plurality of weather modification vehicles for modifying weather.

33. The system of claim 32, wherein each vehicle includes a communication device configured to communicate with the control station.

34. The system of claim 33, wherein each vehicle is configured to transmit signals indicating operation status of the vehicle to the control station through the communication device.

35. The system of claim 34, wherein the operation status of the vehicle includes at least one of status related to the condition of the vehicle, status related to the operation of the solar panel, status of a cloud seeding operation, an amount of fuel in the vehicle, an amount of the at least one weather modification composition, and weather information detected by the vehicle.

36. The system of claim 32, wherein the control station controls a distribution of the plurality of the weather modification vehicles in the air based on weather information.

37. The system of claim 32, wherein the control station receives weather information from the plurality of weather modification vehicles.

38. The system of claim 32, wherein each vehicle includes at least one sensor configured to measure weather information from the air, and each vehicle includes a communication device configured to transmit signals relating to the weather information to the control station.

39. The system of claim 32, wherein the control station includes a processor configured to process the signals received from the plurality of vehicles to analyze weather information, and send signals to the vehicles to adjust weather modification operations conducted by the vehicles based on the analysis of weather information.

40. The system of claim 32, wherein the plurality of vehicles include at least one of an airship, an airplane, an auxiliary vehicle, a satellite, and a balloon.

41. A system for weather modification, comprising:
a plurality of weather modification vehicles, each weather modification vehicle comprising:
a hull;
at least one wing connected to the hull; and
an auxiliary vehicle attached to at least one of the hull and the at least one wing, the auxiliary vehicle carrying a weather modification composition for modifying weather, and the auxiliary vehicle being deployable from the at least one of the hull and the at least one wing; and
a control station configured to control the operation of the plurality of weather modification vehicles for modifying weather.

42. The system of claim 41, wherein each vehicle includes a communication device configured to communicate with the control station.

43. The system of claim 41, wherein at least one of the auxiliary vehicles includes a communication device configured to communicate with at least one of the control station.

44. The system of claim 41, wherein at least one of the auxiliary vehicles includes a communication device configured to communicate with at least one of the weather modification vehicles.

45. The system of claim 42, wherein at least one of the weather modification vehicles is configured to transmit signals indicating operation status of the at least one weather modification vehicle to the control station through the communication device.

46. The system of claim 45, wherein the operation status includes at least one of status related to the condition of the weather modification vehicle, condition of the auxiliary vehicle, status of a cloud seeding operation, an amount of fuel in the weather modification vehicle, an amount of the at least one weather modification composition, and weather information detected by the weather modification vehicle.

47. The system of claim 41, wherein the control station controls a distribution of the plurality of the weather modification vehicles in the air based on weather information.

48. The system of claim 41, wherein the control station controls a distribution and operation of the plurality of auxiliary vehicles after they are deployed from the plurality of weather modification vehicles.

49. The system of claim 41, wherein the control station receives weather information from at least one of the plurality of weather modification vehicles.

50. The system of claim 41, wherein the control station receives weather information from at least one of the plurality of auxiliary vehicles after they are deployed from the plurality of weather modification vehicles.

51. The system of claim 41, wherein at least one of the weather modification vehicles includes at least one sensor configured to measure weather information from the air, and the at least one weather modification vehicle includes a communication device configured to transmit signals relating to the weather information to the control station.

52. The system of claim 41, wherein at least one of the auxiliary vehicles includes at least one sensor configured to measure weather information from the air, and the at least one auxiliary vehicle includes a communication device configured to transmit signals relating to the weather information to at least one of the control station and at least one of the weather modification vehicles.

53. The system of claim 41, wherein the control station includes a processor configured to process the signals received from at least one of a weather modification vehicle and an auxiliary vehicle to analyze weather information, and send signals to at least one of a weather modification vehicle and an auxiliary vehicle to adjust weather modification operations conducted by the at least one of the weather modification vehicle and the auxiliary vehicle based on the analysis of weather information.
